(19) United States
(12) Patent Application Publication
(10) Pub. No.: US 2026/0222774 A1
(43) Pub. Date: Jul. 30, 2026

(54) METHODS AND APPARATUS FOR EXPOSURE OF SENSING SERVICES IN WIRELESS NETWORKS

(71) Applicant: InterDigital Patent Holdings, Inc., Wilmington, DE (US)

(72) Inventors: Jung Je SON, Warrington, PA (US); Taimoor ABBAS, Sainte-Julie (CA); Anuj SETHI, Ottawa (CA); Saad AHMAD, Montreal (CA)

(73) Assignee: InterDigital Patent Holdings, Inc., Wilmington, DE (US)

(21) Appl. No.: 19/149,026

(22) PCT Filed: Feb. 9, 2024
(86) PCT No.: PCT/US2024/015239

§ 371 Date: Jul. 17, 2025

Related U.S. Application Data
(60) Provisional application No. 63/444,515, filed on Feb. 9, 2023.

(51) Int. Cl. H04W 4/38; H04W 28/24; H04W 48/18

(52) U.S. Cl. CPC H04W 4/38; H04W 28/24; H04W 48/18

(57) ABSTRACT

An integrated sensing assistance function (ISANF) may receive, from an Application Function (AF), a request for the establishment of a sensing service. The request may comprise configuration of triggering events for the initiation of the requested sensing service. The triggering events may be associated with a Wireless Transmit-Receive Unit (WTRU) mobility event or data session status. The ISANF may subscribe to an event exposure service from a first Network Function (NF) based on the configured triggering events. The ISANF may receive an event notification from the first NF, which may trigger the sensing service. The ISANF may select a sensing mechanism to be used. The sensing mechanism may be network-based, WTRU-based or collaboration-based sensing. The ISANF may send a sensing request to a second NF in the 5GC. The ISANF may receive sensing results from the second NF and forward the received sensing results to the requesting AF.

### CROSS-REFERENCE TO RELATED APPLICATIONS

This application claims the benefit of U.S. Provisional Application No. 63/444,515, filed Feb. 9, 2023, the contents of which are incorporated herein by reference.

### BACKGROUND

In the 5G Core Network (5GC), events can be exposed externally as well as internally towards Network Functions (NFs). An NF producer may provide an event exposure service to an NF consumer by exposing information associated to one or more events. In order to receive event exposure service by NF producers, NF consumers may subscribe to the event exposure service and NF producers may provide notification of the events to the NF consumers.

### SUMMARY

Event exposure service of sensing events may be provided by a 5G Core (5GC) Network Function (NF) to an Application Function (AF). An AF may request a specific sensing service associated with a triggering condition of a Wireless Transmit-Receive Unit (WTRU). The NF may subscribe to a sensing event exposure service related to the WTRU to monitor for the triggering condition. When the triggering condition is met, the associated sensing service is initiated. In one example use case, the NF may subscribe to a mobility event associated with the WTRU entering a given sensing service area and, upon entry, the NF may trigger a new sensing service to collect sensing data in the given sensing service area.

### BRIEF DESCRIPTION OF THE DRAWINGS

A more detailed understanding may be had from the following description, given by way of example in conjunction with the accompanying drawings, wherein like reference numerals in the figures indicate like elements, and wherein:

FIG. 1A is a system diagram illustrating an example communications system in which one or more disclosed embodiments may be implemented;

FIG. 1B is a system diagram illustrating an example wireless transmit/receive unit (WTRU) that may be used within the communications system illustrated in FIG. 1A according to an embodiment;

FIG. 1C is a system diagram illustrating an example radio access network (RAN) and an example core network (CN) that may be used within the communications system illustrated in FIG. 1A according to an embodiment;

FIG. 1D is a system diagram illustrating a further example RAN and a further example CN that may be used within the communications system illustrated in FIG. 1A according to an embodiment;

FIG. 2 shows an example reference model of a potential architecture of 5G or NextGen network;

FIG. 3 illustrates an example system for pedestrian or animal intrusion detection;

FIG. 4 illustrates an example system for intruder detection in surroundings of a smart home;

FIG. 5 shows an example of a call flow for an event-based sensing procedure;

FIG. 6 shows an example of a call flow for an NF initiated sensing procedure;

FIG. 7 shows an example of a call flow for an NF initiated sensing procedure using the AMF's service operation;

FIG. 8 shows an example of a call flow for Service Request procedure with a triggering associated with a sensing service;

FIG. 9 shows an example flow chart of a process for performing sensing measurements by a WTRU or a BS;

FIG. 10 shows an example flow chart of a process for exposure service of sensing events being triggered by a request for a network operation; and

FIG. 11 shows an example flow chart of a process for exposure service of sensing events being provided to an Integrated Sensing Assistance Network Function (ISANF).

### DETAILED DESCRIPTION

The following acronyms may be referred to in the description that follows:
5GC 5G Core Network
5GS 5G System
NEF Network Exposure Function
AMF Access and Mobility Management Function
AUSF Authentication Server Function
CP Control Plane
DL Downlink
DN Data Network
DNN Data Network Name
MBS Multicast/Broadcast Service
NEF Network Exposure Function
NF Network Function
PCF Policy Control Function
(R)AN (Radio) Access Network
RAT Radio Access Technology
S-NSSAI Single—Network Slice Selection Assistance Information
SMF Session Management Function
TA Tracking Area
UDM Unified Data Management
UL Uplink
UP User Plane
UPF User Plane Function
ISANF Integrated Sensing Assistance NF
SOMF Sensing Operation Management Function

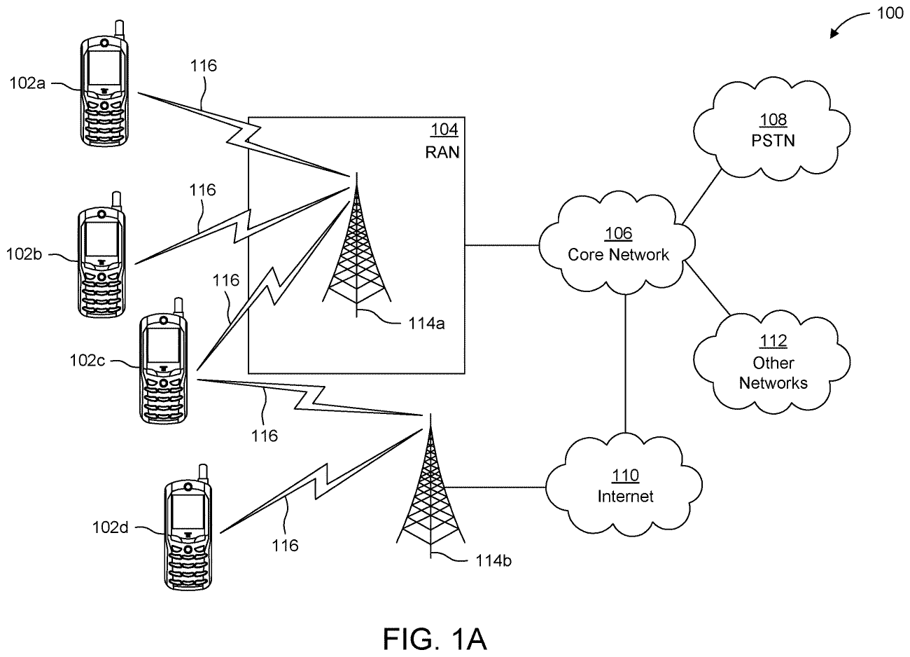

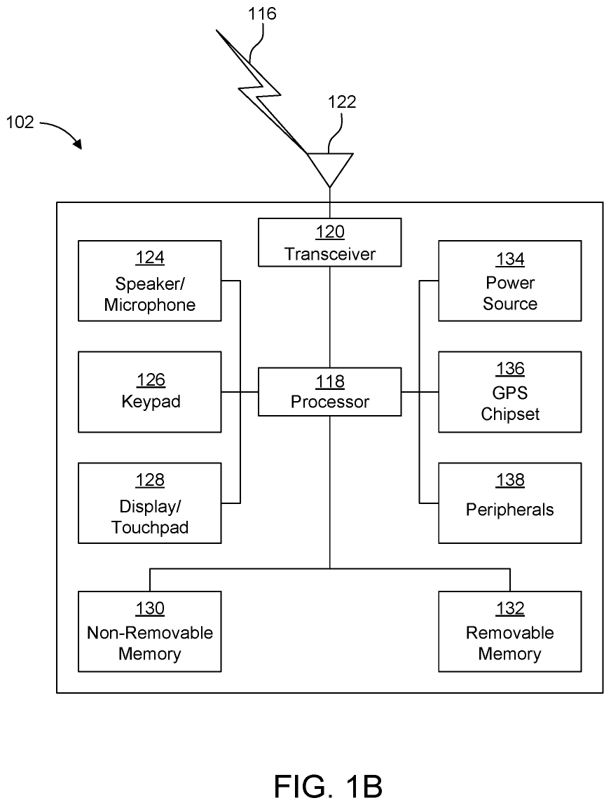

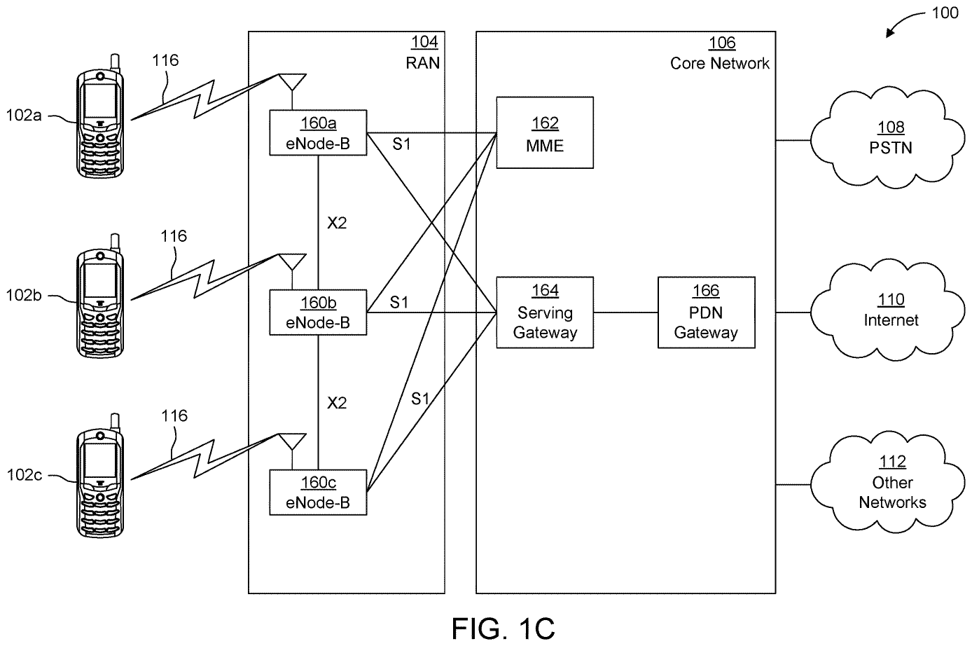

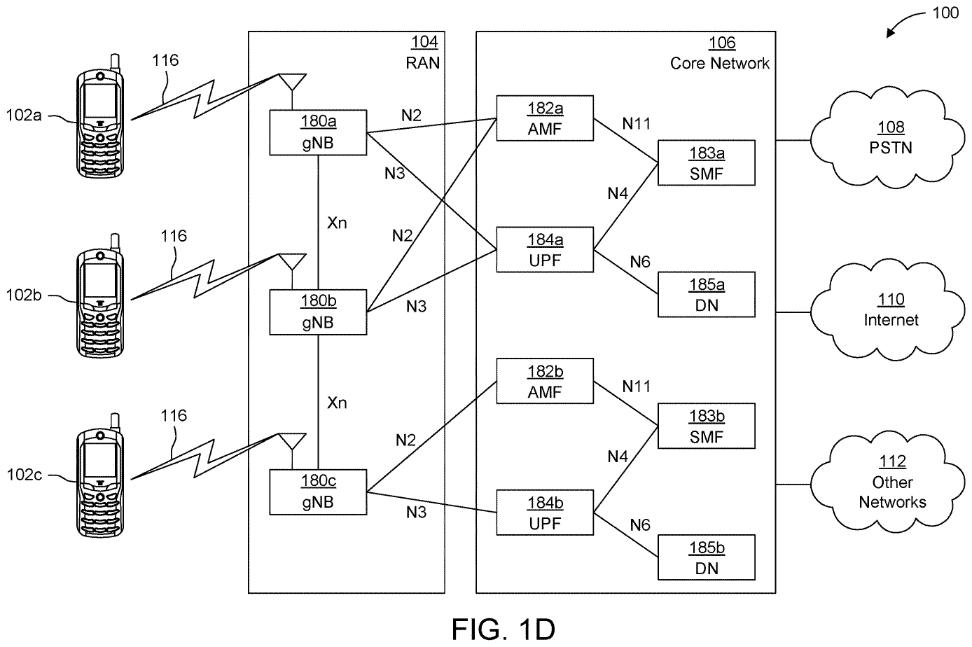

FIG. 1A is a diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail unique-word discrete Fourier transform Spread OFDM (ZT-UW-DFT-S-OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a radio access network (RAN) 104, a core network (CN) 106, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a station (STA), may be configured to transmit and/or receive wireless signals and may include a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a UE.

The communications systems 100 may also include a base station 114a and/or a base station 114b. Each of the base stations 114a, 114b may be any type of device configured to wirelessly interface with at least one of the WTRUs 102a, 102b, 102c, 102d to facilitate access to one or more communication networks, such as the CN 106, the Internet 110, and/or the other networks 112. By way of example, the base stations 114a, 114b may be a base transceiver station (BTS), a NodeB, an eNode B (eNB), a Home Node B, a Home eNode B, a next generation NodeB, such as a gNode B (gNB), a new radio (NR) NodeB, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104, which may also include other base stations and/or network elements (not shown), such as a base station controller (BSC), a radio network controller (RNC), relay nodes, and the like. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in one embodiment, the base station 114a may include three transceivers, i.e., one for each sector of the cell. In an embodiment, the base station 114a may employ multiple-input multiple output (MIMO) technology and may utilize multiple transceivers for each sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104 and the WTRUs 102a, 102b, 102c may implement a radio technology such as Universal Mobile Telecommunications System (UMTS) Terrestrial Radio Access (UTRA), which may establish the air interface 116 using wideband CDMA (WCDMA). WCDMA may include communication protocols such as High-Speed Packet Access (HSPA) and/or Evolved HSPA (HSPA+). HSPA may include High-Speed Downlink (DL) Packet Access (HSDPA) and/or High-Speed Uplink (UL) Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using NR.

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., an eNB and a gNB).

In other embodiments, the base station 114a and the WTRUs 102a, 102b, 102c may implement radio technologies such as IEEE 802.11 (i.e., Wireless Fidelity (WiFi), IEEE 802.16 (i.e., Worldwide Interoperability for Microwave Access (WiMAX)), CDMA2000, CDMA2000 1×, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node B, Home eNode B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In one embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In yet another embodiment, the base station 114b and the WTRUs 102c, 102d may utilize a cellular-based RAT (e.g., WCDMA, CDMA2000, GSM, LTE, LTE-A, LTE-A Pro, NR etc.) to establish a picocell or femtocell. As shown in FIG. 1A, the base station 114b may have a direct connection to the Internet 110. Thus, the base station 114b may not be required to access the Internet 110 via the CN 106.

The RAN 104 may be in communication with the CN 106, which may be any type of network configured to provide voice, data, applications, and/or voice over internet protocol (VoIP) services to one or more of the WTRUs 102a, 102b, 102c, 102d. The data may have varying quality of service (QoS) requirements, such as differing throughput requirements, latency requirements, error tolerance requirements, reliability requirements, data throughput requirements, mobility requirements, and the like. The CN 106 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104 and/or the CN 106 may be in direct or indirect communication with other RANs that employ the same RAT as the RAN 104 or a different RAT. For example, in addition to being connected to the RAN 104, which may be utilizing a NR radio technology, the CN 106 may also be in communication with another RAN (not shown) employing a GSM, UMTS, CDMA 2000, WiMAX, E-UTRA, or WiFi radio technology.

The CN 106 may also serve as a gateway for the WTRUs 102a, 102b, 102c, 102d to access the PSTN 108, the Internet 110, and/or the other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs), any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 116. For example, in one embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In yet another embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. More specifically, the WTRU 102 may employ MIMO technology. Thus, in one embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a Virtual Reality and/or Augmented Reality (VR/AR) device, an activity tracker, and the like. The peripherals 138 may include one or more sensors. The sensors may be one or more of a gyroscope, an accelerometer, a hall effect sensor, a magnetometer, an orientation sensor, a proximity sensor, a temperature sensor, a time sensor; a geolocation sensor, an altimeter, a light sensor, a touch sensor, a magnetometer, a barometer, a gesture sensor, a biometric sensor, a humidity sensor and the like.

The WTRU 102 may include a full duplex radio for which transmission and reception of some or all of the signals (e.g., associated with particular subframes for both the UL (e.g., for transmission) and DL (e.g., for reception) may be concurrent and/or simultaneous. The full duplex radio may include an interference management unit to reduce and or substantially eliminate self-interference via either hardware (e.g., a choke) or signal processing via a processor (e.g., a separate processor (not shown) or via processor 118). In an embodiment, the WTRU 102 may include a half-duplex radio for which transmission and reception of some or all of the signals (e.g., associated with particular subframes for either the UL (e.g., for transmission) or the DL (e.g., for reception).

FIG. 1C is a system diagram illustrating the RAN 104 and the CN 106 according to an embodiment. As noted above, the RAN 104 may employ an E-UTRA radio technology to communicate with the WTRUs 102a, 102b, 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In one embodiment, the eNode-Bs 160a, 160b, 160c may implement MIMO technology. Thus, the eNode-B 160a, for example, may use multiple antennas to transmit wireless signals to, and/or receive wireless signals from, the WTRU 102a.

Each of the eNode-Bs 160a, 160b, 160c may be associated with a particular cell (not shown) and may be configured to handle radio resource management decisions, handover decisions, scheduling of users in the UL and/or DL, and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (PGW) 166. While the foregoing elements are depicted as part of the CN 106, it will be appreciated that any of these elements may be owned and/or operated by an entity other than the CN operator.

The MME 162 may be connected to each of the eNode-Bs 162a, 162b, 162c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in Infrastructure Basic Service Set (BSS) mode may have an Access Point (AP) for the BSS and one or more stations (STAs) associated with the AP. The AP may have access or an interface to a Distribution System (DS) or another type of wired/wireless network that carries traffic in to and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width. The primary channel may be the operating channel of the BSS and may be used by the STAs to establish a connection with the AP. In certain representative embodiments, Carrier Sense Multiple Access with Collision Avoidance (CSMA/CA) may be implemented, for example in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High Throughput (HT) STAs may use a 40 MHz wide channel for communication, for example, via a combination of the primary 20 MHz channel with an adjacent or nonadjacent 20 MHz channel to form a 40 MHz wide channel.

Very High Throughput (VHT) STAs may support 20 MHz, 40 MHz, 80 MHz, and/or 160 MHz wide channels. The 40 MHz, and/or 80 MHz, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse Fast Fourier Transform (IFFT) processing, and time domain processing, may be done on each stream separately. The streams may be mapped on to the two 80 MHz channels, and the data may be transmitted by a transmitting STA. At the receiver of the receiving STA, the above described operation for the 80+80 configuration may be reversed, and the combined data may be sent to the Medium Access Control (MAC).

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHz, and 20 MHz bandwidths in the TV White Space (TVWS) spectrum, and 802.11ah supports 1 MHz, 2 MHz, 4 MHz, 8 MHz, and 16 MHz bandwidths using non-TVWS spectrum. According to a representative embodiment, 802.11ah may support Meter Type Control/Machine-Type Communications (MTC), such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHz, 4 MHz, 8 MHz, 16 MHz, and/or other channel bandwidth operating modes. Carrier sensing and/or Network Allocation Vector (NAV) settings may depend on the status of the primary channel. If the primary channel is busy, for example, due to a STA (which supports only a 1 MHz operating mode) transmitting to the AP, all available frequency bands may be considered busy even though a majority of the available frequency bands remains idle.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 104 and the CN 106 according to an embodiment. As noted above, the RAN 104 may employ an NR radio technology to communicate with the WTRUs 102a, 102b, 102c over the air interface 116. The RAN 104 may also be in communication with the CN 106.

The RAN 104 may include gNBs 180a, 180b, 180c, though it will be appreciated that the RAN 104 may include any number of gNBs while remaining consistent with an embodiment. The gNBs 180a, 180b, 180c may each include one or more transceivers for communicating with the WTRUs 102a, 102b, 102c over the air interface 116. In one embodiment, the gNBs 180a, 180b, 180c may implement MIMO technology. For example, gNBs 180a, 108b may utilize beamforming to transmit signals to and/or receive signals from the gNBs 180a, 180b, 180c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (COMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, the OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., containing a varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, DC, interworking between NR and E-UTRA, routing of user plane data towards User Plane Function (UPF) 184a, 184b, routing of control plane information towards Access and Mobility Management Function (AMF) 182a, 182b and the like. As shown in FIG. 1D, the gNBs 180a, 180b, 180c may communicate with one another over an Xn interface.

The CN 106 shown in FIG. 1D may include at least one AMF 182a, 182b, at least one UPF 184a, 184b, at least one Session Management Function (SMF) 183a, 183b, and possibly a Data Network (DN) 185a, 185b. While the foregoing elements are depicted as part of the CN 106, it will be appreciated that any of these elements may be owned and/or operated by an entity other than the CN operator.

The AMF 182a, 182b may be connected to one or more of the gNBs 180a, 180b, 180c in the RAN 104 via an N2 interface and may serve as a control node. For example, the AMF 182a, 182b may be responsible for authenticating users of the WTRUs 102a, 102b, 102c, support for network slicing (e.g., handling of different protocol data unit (PDU) sessions with different requirements), selecting a particular SMF 183a, 183b, management of the registration area, termination of non-access stratum (NAS) signaling, mobility management, and the like. Network slicing may be used by the AMF 182a, 182b in order to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for MTC access, and the like. The AMF 182a, 182b may provide a control plane function for switching between the RAN 104 and other RANs (not shown) that employ other radio technologies, such as LTE, LTE-A, LTE-A Pro, and/or non-3GPP access technologies such as WiFi.

The SMF 183a, 183b may be connected to an AMF 182a, 182b in the CN 106 via an N11 interface. The SMF 183a, 183b may also be connected to a UPF 184a, 184b in the CN 106 via an N4 interface. The SMF 183a, 183b may select and control the UPF 184a, 184b and configure the routing of traffic through the UPF 184a, 184b. The SMF 183a, 183b may perform other functions, such as managing and allocating UE IP address, managing PDU sessions, controlling policy enforcement and QoS, providing DL data notifications, and the like. A PDU session type may be IP-based, non-IP based, Ethernet-based, and the like.

The UPF 184a, 184b may be connected to one or more of the gNBs 180a, 180b, 180c in the RAN 104 via an N3 interface, which may provide the WTRUs 102a, 102b, 102c with access to packet-switched networks, such as the Internet 110, to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering DL packets, providing mobility anchoring, and the like.

The CN 106 may facilitate communications with other networks. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers. In one embodiment, the WTRUs 102a, 102b, 102c may be connected to a local DN 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to one or more of: WTRU 102a-d, Base Station 114a-b, eNode-B 160a-c, MME 162, SGW 164, PGW 166, gNB 180a-c, AMF 182a-b, UPF 184a-b, SMF 183a-b, DN 185a-b, and/or any other device(s) described herein, may be performed by one or more emulation devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or performing testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

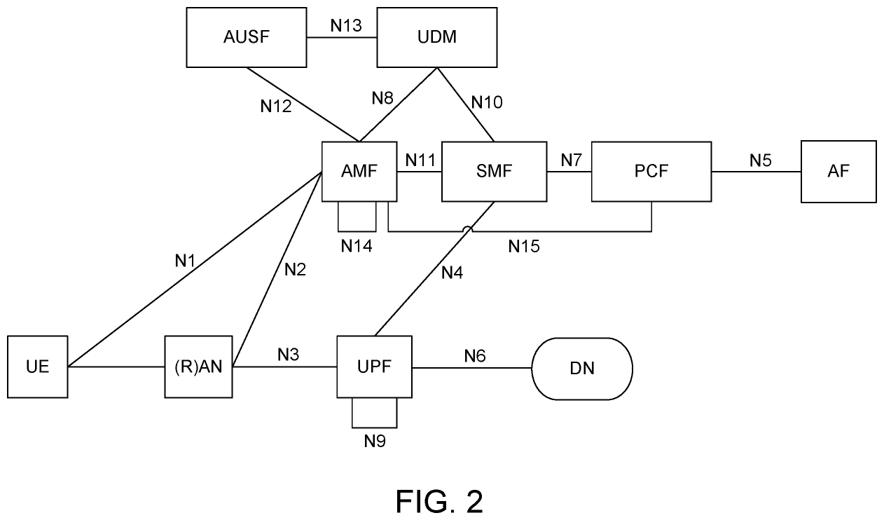

FIG. 2 shows an example reference model of a potential architecture of 5G or NextGen network. RAN may refer to a Radio Access Network based on the 5G Radio Access Technology (RAT) or Evolved E-UTRA that connects to the NextGen core network. The Access Control and Mobility Management Function (AMF) includes e.g., the following functionalities: registration management, connection management, reachability management, mobility management. The Session Management Function (SMF) includes e.g., the following functionalities: session management (including session establishment, modify and release), UE IP address allocation, selection and control of User Plane (UP) function. The User Plane Function (UPF) includes e.g., the following functionalities: packet routing & forwarding, packet inspection, traffic usage reporting.

In the 5G Core Network (5GC), events can be exposed externally as well as internally towards Network Functions (NFs). An “NF producer” is an NF that generates events; an “NF consumer” is an NF that is interested in knowing the information associated to one or more events generated by the NF producer. An NF producer may provide an “event exposure service” to an NF consumer by exposing information associated to one or more events.

In order to receive event exposure service by NF producers, NF consumers may subscribe to the event exposure service and NF producers may provide notification result of the events to the NF consumers. When subscribing to the event, NF consumer may provide parameters such as, event ID, event filter information, including parameter types and values as conditions for notifying the subscribed event ID, Event Reporting Information, target UE(s) information of event reporting, expiry time. The contents of the Event Reporting Information may include e.g., event reporting mode, maximum number of reports, maximum duration of reporting, reporting type, reporting threshold.

A monitoring event feature may be available, and it may be intended for the monitoring of specific events in the 3GPP system followed by the reporting of the event occurrence to the NF consumer, e.g., via the NEF. Example of monitoring events may include Loss of Connectivity, WTRU reachability, Location Reporting, Roaming Status, Communication Failure, etc.

In the case of an internal exposure, exposure of mobility events from the AMF, exposure of communication trends from the SMF, exposure of subscription change from the UDM, etc. can be provided to the NF consumer.

Integrated sensing may include use cases and potential requirements for enhancement of wireless systems to provide sensing services addressing different target verticals and applications, e.g. autonomous/assisted driving, V2X, UAVs, 3D map reconstruction, smart city, smart home, factories, healthcare, and maritime sector solutions.

For integrated sensing, there may be a process of collecting sensing measurement data which may be data collected about radio/wireless signals impacted (e.g. reflected, refracted, diffracted) by an object or environment of interest for sensing purposes and deriving sensing results from processing sensing measurement data. There may be an area defined for sensing, so called sensing service area location, which may be an area location, with or without obstacle, where the 5G system is able to provide sensing service with a certain quality or accuracy.

Non-3GPP entities may also be considered as sources for sensing data. Sensing measurement data from these entities and networks may be considered as transparent to 5GS. The data may be communicated using a standard protocol to an interface defined by the 5GS.

One of use cases for integrated sensing is object detection, for example, pedestrian/animal intrusion detection on a highway or intruder detection in surroundings of smart home.

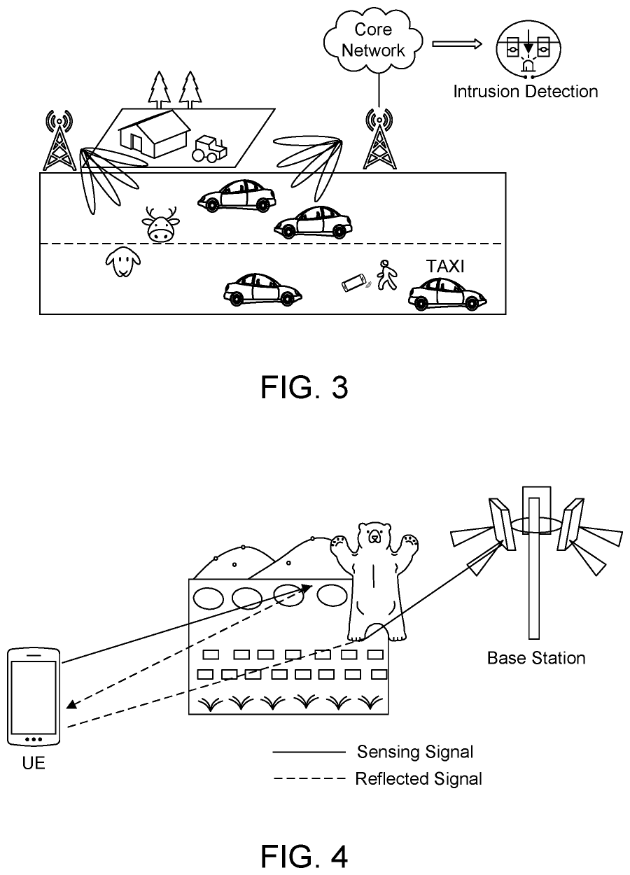

FIG. 3 illustrates an example system for pedestrian or animal intrusion detection.

FIG. 4 illustrates an example system for intruder detection in surroundings of a smart home.

In the scenarios of FIG. 3 and FIG. 4, the base station or the WTRU may detect the intrusion on the sensing area of a base station by itself or by collaboration between the WTRU and the base station. The sensing measurement may be transferred to the network and further processed into the sensing result.

Some use cases on sensing services which may utilize 5GC event exposure; other use cases may utilize sensing service as event exposure service. For example, when a UE sensing service on an environment where the UE is a moving vehicle, as the UE moves into new location e.g., out of a sensing service area, the mobility may be detected and a mobility event may be provided by the AMF. Based on the information provided, the Sensing Control NF may trigger a new sensing service to collect sensing data for the new UE's sensing service area.

As another example, one sensing service may trigger another sensing service. For example, when an unidentified vehicle is detected by a sensing service for intrusion detection, a new sensing service e.g., trajectory tracing of unidentified vehicle, may be activated until the unidentified vehicle moves out of the area of interest. In this case, trajectory tracing service may not be triggered unless a sensing service detects an intrusion.

As another example, an existing NF may be a consumer of an event exposure of integrated sensing. For example, when an intrusion is detected at a smart home, several monitoring cameras may start a real time streaming video service to the control centers. In order to support the real time monitoring service, the SMF may subscribe to a sensing event on intrusion detection and, based on the result, the SMF may activate a PDU session relating to the real time streaming video service.

In order to provide better communication service and sensing service, the 5GS may be able to provide mechanisms to solve following issues: (1) How can the 5GC provide integrated sensing operation based on NF's event notification; (2) When AF's request is for multiple sensing services, how can the 5GC provide efficient sensing services to the AF; and (3) When AF's request is for the communication service relating to the sensing event, how can the 5GC provide efficient communication service to the AF.

In an embodiment for handling sensing service, it may be assumed that there are several new network functions defined such as Integrated Sensing Assistance NF (ISANF) and Sensing Operation Management Function (SOMF). The ISANF and the SOMF are logical entities and may be collocated with other entities. In an example, all NEF, ISANF and SOMF may be implemented at the same entity. In another example, SOMF may be implemented at AMF, RAN, or another NF.

The ISANF may oversee the interaction with the Application Function for sensing service. The ISANF understands the sensing service request from the Application Function and may derive corresponding requested sensing mechanism. After determining the requested sensing mechanism, it may forward the request to the AMF which serves the requested area or the requested entities. Later, the ISANF may receive the report on sensing directly from the AMF or from other Network Entity e.g. Sensing Operation Management Function (SOMF) and it may report the result to the Application Function.

When an Application Function is a 3^{rd} party application which is not a trusted entity of 5GS, the Application Function and the ISANF may communicate through NEF (Network Exposure Function).

The SOMF may handle coordination of sensing operations among Base Stations (BSs) and WTRUs. Based on information received from an AMF, for example requested sensing area, BSs and WTRUs' list, or requested sensing mechanism with QoS requirement, the SOMF may derive coordination information for sensing operation. For example, the SOMF may decide the role of sensing operation such as sender(s) of sensing signal(s), receiver(s) of sensing signal(s), entity to collect the sensing measurement data, entity to calculate sensing result. For example, the SOMF may decide sensing period, the waveform of a sensing signal, and/or ask BS(s) or sender(s) resource assignment for sending sensing signal at the sensing period. A sensing signal may be, e.g., a specific type of radio waveform. A sensing signal may be transmitted over radio resource assigned for sensing. A sensing signal may be different per sender, per sensing occasion, and/or per sensing mechanism.

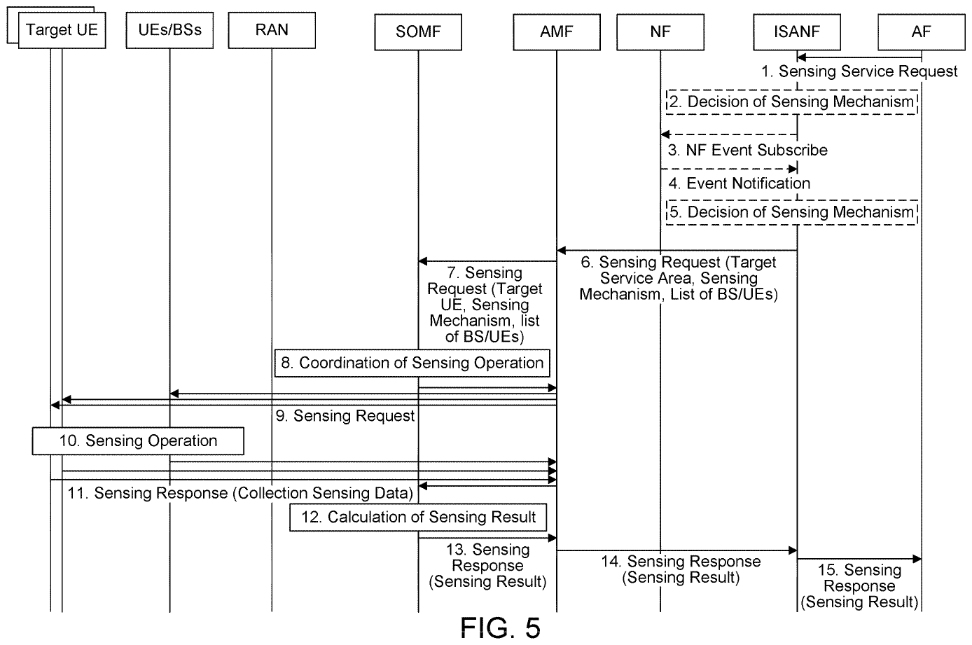

FIG. 5 shows an example of a call flow for an event-based sensing procedure.

At (1), a Sensing Service Request message comes from the Application Function (AF). The message may include a specific type of sensing request e.g., intrusion detection, raining detection, drone detection, etc., and area information in which the sensing needs to be performed.

The Sensing Service Request message may include the conditional parameters indicating the event that triggers the requested sensing service. The conditional parameters may include an event associated with a target WTRU such as mobility event or session event to be monitored, and conditions to detect for the event. For example, a traffic monitoring sensing event may be requested whenever a target WTRU enters a new sensing service area during some requested time period. In this case, the event is a target WTRU's entering or departing the service area and the condition occurs when the event is detected during some requested time period. In another example, a rain monitoring sensing event may be requested at a WTRU's service area while the WTRU (here, UAV) is in connected mode. In this case, event is target WTRU's entering at the service area and a WTRU entering connected mode, and the condition occurs during some requested time period.

The Sensing Service Request message may include the WTRU's information which is needed to perform sensing (i.e., collecting sensing measurements data). The Sensing Service Request message may include specific QoS requirements on the sensing service, e.g., sensing accuracy, latency, sensing frequency, resolution, etc.

The Sensing Service Request message may include Network Slice information, such as Single-Network Slice Selection Assistance Information (S-NSSAI), at which the sensing service needs to be provided. When Network Slice information is provided, an entity such as the NF belonging to the Network Slice, and WTRUs allowed at the Network Slice, may be involved in the operation for the sensing service. When target WTRUs are included with Network Slice information, only the WTRUs which are allowed to operate at the Network Slice may be considered. When multiple target WTRUs are included, the ISANF may consider the sensing service area to be big enough to cover the target WTRUs' area.

At (2), the ISANF may translate the sensing service request into the requested sensing mechanism that may need to be performed in 5GS, e.g. BS only based sensing, BS and UE collaboration-based sensing, or WTRU only based sensing, and derive the requested event services for the conditional parameters for the requested sensing service.

At (3), based on the derived requested event service for the condition, the ISANF may subscribe to relevant NF's event. For example, if a traffic monitoring sensing event is requested with an associated condition when a target WTRU enters new sensing service, the ISANF may subscribe to a mobility event exposure service of a target WTRU's serving AMF to detect when the target WTRU moves out of sensing service area.

When Network Slicing information is received a (1), it may be included in the subscription of event exposure.

At (4), when requested event (3) happens, the ISANF may be notified of the event from the relevant NF. When the ISANF is notified the result of event, target WTRU's location information, such as, serving AMF's information, target WTRU's location, or target WTRU's registration area, may be provided.

At (5), when the ISANF is notified of the event, it may satisfy the condition for the requested sensing service, the ISANF may derive the requested sensing mechanism, the requested sensing service area, and a list of BSs and WTRUs for sensing operation in the requested sensing service area.

When Network Slice information is included at (1), only network entities such as AMF, RAN, SOMF, belonging to the Network Slice and WTRUs allowed at that Network Slice may be selected.

If the target WTRU's location information is provided at (4), it may be considered as input for determining or calculating the sensing service area, and/or a list of BSs and WTRUs for performing a sensing operation.

Additionally, the ISANF may refer to the PCF to check the SLA for a sensing service requested by an Application Function (AF) and decide whether to support the requested sensing service, and if so, which QoS requirements on the requested sensing service should be supported.

If the request is for sensing data in a fixed sensing service area location, the ISANF may derive the candidate list of BSs and WTRUs performing sensing mechanism on the requested area.

Alternatively, the ISANF may request the AMF to derive the sensing service area according to the target WTRU's location and provide a complete list of tracking area identities (TAIs) or list of BSs (gNB IDs) for all the associated sensing capable WTRUs. Based on the reported target WTRU's location the ISANF may determine sensing service area and the ISANF may select or derive the candidate list of BSs and WTRUs performing sensing mechanism on the determined sensing service area. Or the ISANF may request AMF to provide a candidate list of BSs and WTRUs capable of sensing according to the requested sensing service area, or based on the target WTRU's identities and location. In this case, there may be extra signaling between the ISANF and the AMF (6) to query sensing service area information, or a list of BSs and WTRUs per sensing service area or the target WTRU's location.

Based on capabilities of each BS and WTRU, the ISANF may decide the sensing mechanism and the list of BSs and WTRU(s) to perform the sensing mechanism. If there is any WTRU supporting a Non-3GPP (N3GPP) sensing method, those N3GPP sensing capabilities may also be considered when choosing the sensing mechanism, which may utilize N3GPP sensing data.

At (6), the ISANF may send a sensing request (e.g., Nisanf_Sensing Request message) to the AMF which serves the target WTRU or which serves the requested area and are connected with or controlling the BS and WTRU(s) in the list of BSs and WTRUs to perform the sensing. When an AMF cannot serve the target WTRUs or the requested area, multiple AMFs may be selected to serve the target WTRUs or the requested area, and ISANF may send Nisanf_Sensing Request message to each selected AMF.

The Sensing Request may include the requested sensing area information (e.g., list of TAIs, list of cell IDs), list of BSs (gNB IDs) and list of WTRUs, application ID, requested sensing mechanism with QoS requirement and/or Network Slice information.

Alternatively, when the ISANF knows the SOMF′ service area, the ISANF may include the target the SOMF in the message.

When Network Slice information is included, only a network entity such as RAN, SOMF, etc. belonging to the Network Slice may be selected for operation. And the WTRUs in the list of WTRUs may be selected among the WTRUs allowed at the Network Slice.

At (7), after receiving the Nisanf_Sensing Request from the ISANF, the AMF may send an sensing request (e.g., Namf_Sensing Request message) to the SOMF. The Namf_Sensing Request message may include requested sensing mechanism with QoS requirement, a list of BSs and UEs involved, an application ID, a target area, and network slice information.

Alternatively, BSs and WTRUs' list and/or sensing mechanism may be decided by the SOMF or the AMF. For example, when AMF/SOMF decides the sensing mechanism and/or BSs and WTRUs list, AMF/SOMF may determine a candidate BS and WTRU list based on requested sensing area information. And, AMF/SOMF may determine a sensing mechanism and target BS and WTRU list based on requested a sensing mechanism with QoS requirements, and capability of entities and allowed or restricted application list for sensing of each entities in the candidate list. In this case, ISANF/AMF may include requested sensing area information and may not include list of BSs and WTRUs and/or sensing mechanism in the Nisanf_Sensing Request and Namf_Sensing Request.

When Network Slice information is included, the WTRUs in the list of WTRUs may be selected among the WTRUs allowed at the Network Slice.

The list of BSs and WTRUs involved in Namf_Sensing Request may be different from the BSs and WTRUs list in Nisanf_Sensing Request message as the AMF may down-select per WTRU's and BS's state and circumstance, e.g. resource load, WTRU's capability on sensing operation, WTRU's mobility state such as idle mode, connected mode, or connected but RRC-Inactive mode.

The AMF may coordinate with PCF or UDM for checking policy configuration on candidates WTRU's capabilities. For example, a WTRU's capabilities may include a list of allowed or disallowed application IDs for sensing operation by WTRU. Based on coordination with PCF and UDM, the AMF may down select the list of WTRUs for sensing operation.

At (8), the SOMF may develop coordination information for controlling the sensing operation of BSs and WTRUs in the list according to the requested sensing mechanisms and QoS requirements, e.g., the SOMF may decide the role of sensing operations such as sender(s) of sensing signal(s), receiver(s) of sensing signal(s), etc. and may decide the sensing period, and/or the waveform of sensing signal.

Alternatively, if a BSs and WTRU's list is not provided, the SOMF may derive the BSs and WTRUs list for sensing operation according to the requested sensing service area and may develop coordination information for controlling the sensing operation of BSs and UEs in the list according to the requested sensing mechanism and QoS requirements.

The SOMF may coordinate with PCF or UDM for checking policy configuration on candidates UE's capability for example list of allowed or disallowed application IDs for sensing operation by UE. Based on coordination with PCF and UDM, SOMF may down-select the list of WTRUs for sensing operation.

Alternatively, resource assignment for sending sensing signal may be decided by BS(s) sensing signal and may be informed to the other entity, i.e., BSs and UEs in the list.

At (9), the SOMF may send a Sensing Request to the entities involved in the sensing operation. When sending Sensing Request to the WTRU involved, the SOMF may send it through an AMF using NAS container. When sending Sensing Request to the BS involved, the SOMF may send it using direct communication between the SOMF and BS or through the AMF using N2 connection.

The Sensing Request message for a WTRU and the Sensing Request message for a BS may include different information. For example, a Sensing Request message for a WTRU may include a sensing area which the WTRU needs to sense, BS's information to which WTRU needs to listen, etc. For example, a Sensing Request message for the BS may include some configuration information e.g., frame structure, resource assignment information, etc., and/or a list of BSs information to coordinate to send sensing signal.

At (10), based on the coordination from SOMF, BSs and WTRUs perform collecting sensing measurement data.

At (11), the collected sensing measurement data may be sent to the SOMF.

When sending collected sensing measurement data, it may be collated at a WTRU or a BS at first and then may be sent to the SOMF. Which entity will collect the sensing data may be indicated in coordination information.

At (12), the SOMF may calculate sensing results using the collected sensing measurement data received at (11).

At (13), the SOMF may send sensing results to the AMF via Namf_Sensing Response.

Alternatively, other entities, for example one of the BS or the WTRU in the list, or another dedicated network function, may calculate sensing results. For example, if a BS calculates sensing results, the collected sensing measurement data may be sent to the BS before (11). Calculation results may be sent to the SOMF by the BS at (11). And, in some cases (12) may not be performed.

At (14)-(15), after receiving sensing results, the AMF may report the sensing results to the ISANF via Nisanf_Sensing Response. And, the ISANF may report the sensing results to the AF via a Service Response message. When multiple AMFs are involved for the sensing service, the collected sensing result from AMFs involved may be included at the sensing response to the AF at (15).

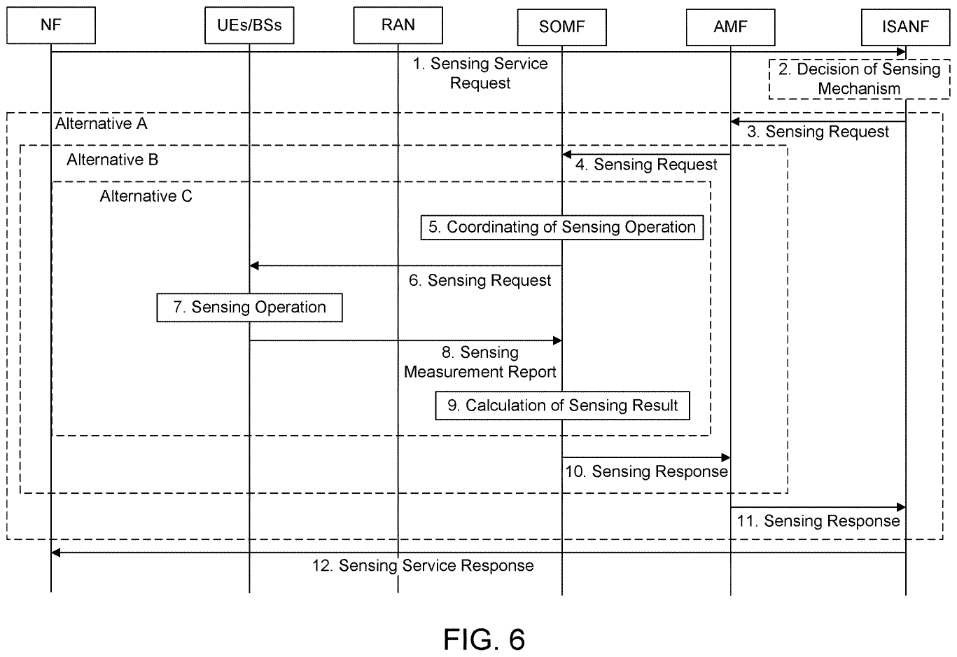

FIG. 6 shows an example of a call flow for an NF initiated sensing procedure.

At (1), based on some configuration, or a request from other NF or AF, NF may be triggered to request a sensing service and may send Sensing Service Request message. The Sensing Service Request message may include a specific type of sensing service, e.g., intrusion detection, traffic monitoring, raining detection, drone detection, etc. The Sensing Service Request message may include specific QoS requirements on the sensing service, e.g., sensing accuracy, latency, sensing frequency, resolution. The Sensing Service Request message may request some sensing mechanism that needs to be performed in 5GS, e.g., BS only based sensing, BS and WTRU collaboration-based sensing, WTRU only based sensing.

When the sensing service is requested for a fixed sensing service area, the sensing service area may be included. When the sensing service is for specific target WTRU(s), the target WTRU(s) information may be included. When the target WTRU(s) information is included but the sensing service area is not included, the sensing service area may be determined according to the target WTRU(s)'s location at the time when the sensing operation needs to be performed.

The Sensing Service Request message may request an event triggered sensing service report, or periodic sensing service report. When an event triggered sensing service report is requested, it may include a sensing report triggering condition. When there is a triggering condition included, the other parameters such as sensing report start time and sensing report ending time may also be included. The triggering condition may include logical data, for example, if some event is detected or not; and/or a value to trigger the event reporting, such as to report the event when it is detected for longer than some value, or to report the event when the number of detected events is greater than some value.

The Sensing Service Request message may request a periodic sensing result report. If the periodic result report is requested, sensing report start time, sensing report ending time and periodicity of sensing report may be included.

At (2), if a requested sensing mechanism is included in the message at (1), it may be included at the Sensing Request message at (3). Otherwise, the assistance NF (ISANF) may translate requested specific type of sensing service at the Sensing Request message into the requested sensing mechanism needs to be performed in 5GS, e.g., BS only based sensing, BS and WTRU collaboration-based sensing, or WTRU only based sensing.

Based on the sensing mechanism and included service area information or based on target WTRU's location, ISANF may derive the candidate list of BSs and WTRUs performing a sensing mechanism on the requested area. Alternatively, the AMF may derive the candidate list of BSs and WTRUs after receiving a sensing request from ISANF at (3)

At (3), the ISANF may send a Nisanf_Sensing Request message to the AMF which is serving the target WTRU(s). The Sensing Request message may include the requested sensing report type, requested sensing area information, target WTRU ID(s), application ID, and requested sensing mechanism with QoS requirement. It may include a candidate list of BSs and WTRUs for sensing operations.

When the sensing request is for a periodic sensing service report or event triggered sensing service report, the sensing request may include related parameters for the requested sensing report type. For example, the related parameters may include, for the periodic sensing service report, sensing report start time, sensing report ending time, and periodicity of sensing report. For event triggered sensing service report, sensing report start time, sensing report ending time and sensing report triggering condition may be included. All or some of these may be included.

The ISANF may manage service request ID so that the ISANF may map the requested sensing service, and the recipient of a sensing service and service request ID may be included in Nisanf_Sensing Request message.

When multiple target WTRUs are included in the Sensing Service Request message at (1) and target WTRUs are served by different serving AMF, to each AMF, sensing request can be sent. The sensing request may include target WTRUs served by the AMF.

At (4), after receiving the Nisanf_Sensing Request from the ISANF, the AMF may send Namf_Sensing Request message to the SOMF. The Namf_Sensing Request message may include the requested sensing report type and relating parameters, a service request ID, the requested sensing mechanism with QoS requirement, a list of BSs and WTRUs, application ID, and/or target WTRU ID.

If there is a candidate list of BSs and WTRUs received at (3), the candidate list can be used to derive the list of BSs and WTRUs to participate in the sensing procedure. The AMF may derive the list of BSs and WTRUs based on sensing mechanism, requested service area, and the candidate list of BSs and WTRUs, when available.

At (5), the SOMF may develop coordination information for controlling the sensing operation of BSs and WTRUs in the list according to the requested sensing mechanism and QoS requirement, e.g., the SOMF may decide the role of sensing operations such as sender(s) of sensing signal(s), receiver(s) of sensing signal(s), etc. and may decide sensing period and the waveform of sensing signal.

Alternatively, if a candidate BSs and WTRUs list is not provided, the SOMF may derive the BSs and WTRUs list for sensing operations according to the requested sensing service area and may develop coordination information for controlling the sensing operation of BSs and WTRUs in the list according to the requested sensing mechanism and QoS requirements.

The SOMF may coordinate with PCF or UDM for verifying the policy configuration on candidates WTRU's capability, for example, list of allowed or disallowed application IDs for sensing operation by a WTRU. Based on coordination with PCF and UDM, SOMF may down-select the list of WTRUs for sensing operation.

The SOMF may request the BS(s) resource assignment for sending sensing signal at the sensing period. When resource assignment for periodic sensing operation is requested, related parameters such as, time period and periodicity, may be included in the request.

Alternatively, resource assignment for sending sensing signals may be decided by the BS(s) and may be informed the other entity, i.e., BSs and WTRUs in the list.

At (6), the SOMF may send a Sensing Request message to the entities involved in the sensing operation. When sending a Sensing Request message to the WTRU(s) involved, the SOMF may send it through the AMF, using NAS container. When sending a Sensing Request message to the BS(s) involved, the SOMF may send it using direct communication between the SOMF and the BS or through the AMF using N2 connection.

A Sensing Request message for a WTRU and a Sensing Request message for a BS may include different information. For example, the Sensing Request message for a WTRU may include sensing area which WTRU need to sense, BS's information to which WTRU need to listen, etc. For example, the Sensing Request message for a BS may include some configuration information such as the frame structure and the resource assignment information and a list of BSs' information to coordinate to send a sensing signal.

When the requested sensing report type is for a periodic sensing service report or event triggered sensing service report, the sensing service request may include the parameters for periodic sensing such as start time, ending time, periodicity of sensing so that involved BSs and WTRUs may conduct periodic sensing operations based on the coordination information.

When service request ID is received at (4), it may be included in the Sensing request.

The Sensing Request message may include the ID or Address of the SOMF as serving SOMF information.

At (7), based on the coordination from the SOMF, the BSs and the WTRUs may perform the collecting of sensing measurement data.

At (8), the collected sensing measurement data may be sent to the SOMF.

When a service request ID is received at (6), it may be included in the report to the SOMF.

If the serving SOMF information is received at (6), the report may be sent to the SOMF indicated by the serving SOMF information.

When sending collected sensing measurement data, it may be collated at a WTRU or at a BS first, and then may be sent to the SOMF. Which entity will collate the sensing data may be indicated in coordination information.

At (9), the SOMF may calculate the sensing result using the collected sensing measurement data received at (8).

At (10), the SOMF may send sensing result to the AMF via a Namf_Sensing Response message. Service request ID may be included if it is received at (8).

When periodic sensing operation is requested by the SOMF, the BSs and the WTRUs may perform (7) and (8) per requested time interval and periodicity. The SOMF may perform (9) and (10) whenever a sensing response is received from WTRUs and BSs.

In alternative C in FIG. 6, when sensing report type is a periodic sensing report, the SOMF may repeat (5) based on the periodicity and (6), (7), (8) and (9) will be repeated during the requested time interval. The SOMF may repeat sending sensing responses to the AMF at (10) during the requested time interval. When sensing report type is event triggered sensing report, the SOMF may repeat (5) and (6), (7), (8) and (9) will be repeated until the calculated sensing result at (9) to satisfy the condition of event triggered sensing service report. When the calculated sensing result satisfy the condition of event triggered sensing service report, the SOMF may send sensing response including sensing result to the AMF.

After receiving sensing result, the AMF reports the sensing result to the ISANF via Nisanf_Sensing Response at (11). And the ISANF reports the sensing result to the NF via Sensing Service Response at (12).

In alternative B in FIG. 6, when sensing report type is periodic sensing report, the AMF may repeat (4) based on the periodicity and (5), (6), (7), (8), (9), and (10) will be repeated during the requested time interval.

The AMF may repeat sending sensing response to the ISANF at (11) during the requested time interval. When sensing report type is event triggered sensing report, the AMF may repeat step 4) and (5), (6), (7), (8), (9), and (10) will be repeated until the result received in at (10) satisfies the condition of event triggered sensing service report. When the calculated sensing result satisfy the condition of event triggered sensing service report, the AMF may send sensing response including sensing result to the ISANF. For sensing request with sensing report type is periodic sensing report or event triggered sensing report, when the AMF repeats (4) based on included parameter periodically or until the condition of event triggered sensing report satisfies, sensing service type and related parameters may be maintained within the AMF and those parameters may not be included in sensing request at (4).

In alternative A in FIG. 6, when sensing report type is periodic sensing report, the ISANF may repeat (3) based on the periodicity and (4), (5), (6), (7), (8), (9), (10), and (11) will be repeated during the requested time interval. The ISANF may repeat sending sensing response to NF at (12) during the requested time interval. When sensing report type is event triggered sensing report, the ISANF may repeat (3) and step (5), (6), (7), (8), (9), and (10) will be repeated until the result received in at (11) satisfies the condition of event triggered sensing service report. When the received sensing result satisfies the condition of event triggered sensing service report, the ISANF may send sensing response including sensing result to the NF at (12). For sensing request with sensing report type is periodic sensing report or event triggered sensing report, when the ISANF repeats (3) based on included parameter periodically or until the condition of event triggered sensing report satisfy, sensing service report type and related parameters may be maintained within the ISANF and those parameters may not be included in sensing request at (3).

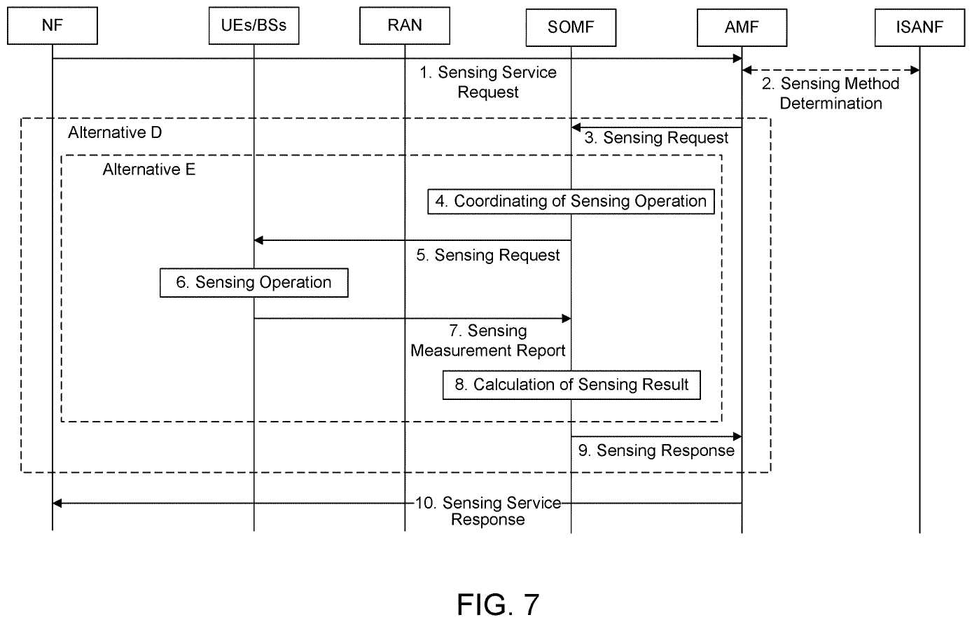

FIG. 7 shows an example of a call flow for an NF initiated sensing procedure using the AMF's service operation.

At (1), based on some configuration or a request from other NF or AF, the NF may be triggered to request a sensing service and may send Sensing Service Request message to the target WTRU's serving AMF or the AMF that serves the requested sensing service area. The Sensing Service Request message may include a specific type of sensing service, e.g., intrusion detection, traffic monitoring, rain detection, drone detection, etc. The Sensing Service Request message may include specific QoS requirements on the sensing service, e.g., sensing accuracy, latency, sensing frequency, resolution. The Sensing Service Request message may request the sensing mechanism that needs to be performed in the 5GS, e.g. BS only based sensing, BS and WTRU collaboration-based sensing, or UE only based sensing. When the sensing service is requested for a fixed sensing service area, the sensing service area may be included.

When the sensing service is for WTRU(s), the target WTRU(s) information may be included.

When target WTRU(s) information is included but sensing service area is not included, sensing service area may be determined according to the target WTRU(s)'s location at the time when a sensing operation needs to be performed.

The Sensing Service Request message may request an event triggered sensing service report or periodic sensing service reports. When an event triggered sensing service report is requested, it may include a sensing report triggering condition. When there is triggering condition included, the other parameters such as sensing report start time and sensing report ending time may be included also. The triggering condition may include logical data, for example, if some event is detected or not, and/or some value to trigger the reporting of the event, for example, to report an event when it is detected for longer than some value, or to report an event when the number of detected events is greater than some value.

The Sensing Service Request message may request periodic sensing result reports. If the periodic result report is requested, sensing report start time, sensing report ending time, and periodicity of sensing report may be included.

At (2), after receiving sensing service request from the NF, the AMF may communicate with the ISANF to determine a sensing mechanism from the requested sensing service. The ISANF may also provide the candidate list of BSs and WTRUs performing the derived sensing mechanism on the requested area based on the derived sensing mechanism and the included service area information.

At (3), for the requested sensing service, the AMF may send a Namf_Sensing Request message to the SOMF. The Namf_Sensing Request message may include requested sensing report type and relating parameter, service request ID, requested sensing mechanism with QoS requirement, list of BSs and WTRUs, application ID, and target WTRU ID.

If there is a candidate list of BSs and WTRUs received at (2), the candidate list can be used to derive the list of BSs and WTRUs to participate in the sensing procedure. The AMF may derive the list of BSs and WTRUs based on sensing mechanism, requested service area, and the candidate list of BSs and WTRUs, when available.

At (4), the SOMF may develop coordination information for controlling the sensing operation of BSs and WTRUs in the list according to the requested sensing mechanism and QoS requirement, e.g. the SOMF may decide the role of sensing operation, such as sender(s) of sensing signal(s) and receiver(s) of sensing signal(s), and may determine the sensing period, and/or the waveform of sensing signal.

Alternatively, if BSs and WTRU's list is not provided, the SOMF may derive the BSs and WTRU's list for sensing operation according to the requested sensing service area and may develop coordination information for controlling the sensing operation of BSs and WTRUs in the list according to the requested sensing mechanism and QoS requirements.

The SOMF may coordinate with the PCF or UDM for verifying the policy configuration on candidates WTRU's capabilities. This may include a list of allowed or disallowed application IDs for sensing operation by a WTRU. Based on coordination with the PCF and UDM, the SOMF may down-select the list of WTRUs for sensing operation.

The SOMF may request the BS(s) resource assignment for sending a sensing signal at the sensing period and time period and periodicity that may be included in the request when resource assignment for periodic sensing operation is requested.

Alternatively, resource assignment for sending sensing signal may be decided by the BS(s) sensing signal and may be informed to the other entity, i.e. to the BSs and UEs in the list.

At (5), the SOMF may send a Sensing Request message to the entities involved in the sensing operation. When sending a Sensing Request message to a WTRU involved, the SOMF may send it through the AMF using NAS container. When sending Sensing Request to a BS involved, the SOMF may send it using direct communication between the SOMF and the BS or through the AMF using N2 connection.

A Sensing Request message for a WTRU and a Sensing Request message for a BS may include different information. For example, a Sensing Request message for a WTRU may include a sensing area which WTRU needs to sense, BS's information to which WTRU needs to listen, etc. For example, a Sensing Request message for a BS may include some configuration information such as the frame structure and the resource assignment information, and a list of BSs' information to coordinate to send sensing signal.

When the requested sensing report type is for a periodic sensing service report, the sensing service request may include the parameters for periodic sensing such as start time, ending time, periodicity of sensing so that involved BSs and UEs may conduct periodic sensing operations based on the coordination information.

When a service request ID is received in at (4), it is included in the Sensing request.

The Sensing Request message may include the ID or Address of the SOMF as the serving SOMF information.

At (6), based on the coordination from the SOMF, the BSs and the WTRUs collect sensing measurement data.

At (7), the collected sensing measurement data are sent to the SOMF.

When service request ID is received at (5), it is included in the report to the SOMF.

If the serving SOMF information is received at (5), the report is sent to the SOMF which is indicated by the serving SOMF information.

When sending collected sensing measurement data, it may be collated at a WTRU or a BS at first and then may be sent to the SOMF. Which entity will collect the sensing data may be indicated in coordination information.

At (8), the SOMF may calculate sensing results using collected sensing measurement data received at (7).

At (9), the SOMF sends sensing results to the AMF via Namf_Sensing Response. Service request ID is included if it is received at (7).

When a periodic sensing operation is requested by the SOMF, the BSs and the WTRUs perform (6) and (7) based on the requested time interval and periodicity. And the SOMF may perform (8) and (9) whenever a sensing response is received from WTRUs and BSs.

In alternative E in FIG. 7 when a sensing report type is periodic sensing report, the SOMF may repeat (4) based on the periodicity and (5), (6), (7), and (8) will be repeated during the requested time interval. The SOMF may repeat sending sensing response to the AMF at (9) during the requested time interval. When sensing report type is an event triggered sensing report, the SOMF may repeat (4) and (5), (6), (7), and (8) will be repeated until the calculated sensing result at (8) satisfy the condition of event triggered sensing service report. When the calculated sensing result satisfies the condition of event triggered sensing service report, the SOMF may send a sensing response including sensing results to the AMF in at (9).

At (10), after receiving sensing result, the AMF may report the sensing result to the NF via Sensing Service Response.

In alternative D in FIG. 7, when a sensing report type is a periodic sensing report, the AMF may repeat (3) based on the periodicity and (4), (5), (6), (7), (8), and (9) will be repeated during the requested time interval. The AMF may repeat sending a sensing response to NF at (10) during the requested time interval. When a sensing report type is event triggered sensing report, the AMF may repeat (3) and (4), (5), (6), (7), (8), and (9) will be repeated until the result received at (9) satisfies the condition of event triggered sensing service report. When the received sensing result satisfies the condition of the event triggered sensing service report, the AMF may send a sensing response including sensing results to the NF. For a sensing request with a sensing report type as periodic sensing report or event triggered sensing report, when the AMF repeats (3) based on included parameter periodically or until the condition of event triggered sensing report satisfy, the sensing service type and related parameters may be maintained within the AMF and those parameters may not be included in sensing request at (3). Exposure service of sensing events is described herein. Relating to sensing service, NF involved for integrated sensing service such as ISANF, AMF and SOMF may provide sensing service to other NFs.

The ISANF may provide Sensing Method Translation Service to the other NFs. Sensing Method Translation Service may be the service to determine sensing method executable in 5GC for the requested sensing service.

NF Consumer e.g., NEF and the AMF, may send a Sensing Method Translation Service Request to the ISANF. The Sensing Method Translation Service Request may include requested sensing service and may include requested sensing service area and target WTRU information.

The ISANF may respond with Sensing Method Translation Service Response to the NF Consumer. The response message includes sensing method executable in 5GC for the requested sensing service and may additionally include a list of BSs and WTRUs to perform the sensing method in the requested sensing service area or to serve sensing service based on a target WTRU's location.

The ISANF may provide an event exposure service on sensing to the other NF.

When an NF Consumer subscribes to the sensing event of the ISANF, the event subscription message may include requested sensing event information. Additionally, the request may include requested target WTRU's information, requested sensing service area, and a threshold value to report the result. For example, a NF consumer may request to report when rain is detected at area surrounding target WTRU's location. As another example, a NF consumer may request to report intrusion detection event at some area if the detected intrusion last for several seconds.

After receiving sensing event subscription, based on the requested sensing event information and other parameter such as sensing service area and threshold values, the ISANF may trigger sensing operation until the sensing result based on the measured sensing data at the requested sensing service area or at the requested target UE's location or surrounding area exceeds the requested threshold value. When sensing result exceeds the requested threshold value, the ISANF notifies the sensing result and any other related information to the NF consumer subscribed or other NF indicated at the subscription of sensing event. The AMF and/or the SOMF may provide event exposure service on sensing to the other NF.

When an NF Consumer subscribes to the sensing event of the AMF or the SOMF, the event subscription message may include requested sensing event information and/or requested sensing method. Additionally, the request may include requested target WTRU's information, requested sensing service area, list of BSs and WTRUs information to perform requested sensing event and threshold value to report the result. When receiving sensing event subscription from NF Consumer, NF Provider i.e., the AMF or the SOMF may derive a sensing method from requested sensing event information and may derive a list of BSs and WTRUs information to perform sensing operation based on the determined sensing method. The AMF or the SOMF may use sensing method translation service of the ISANF in order to determine sensing method and derive the list of WTRUs and BSs.

After receiving sensing event subscription, based on the requested sensing event information and other parameters such as sensing service area and threshold values, NF Producer i.e., the AMF or the SOMF may trigger a sensing operation until the sensing result based on the measured sensing data at the requested sensing service area or at the requested target UE's location or surrounding area exceeds the requested threshold value. When a sensing result exceeds the requested threshold value, NF Producer notifies the sensing result and any other related information to the NF consumer subscribed or other NF indicated at the subscription of sensing event.

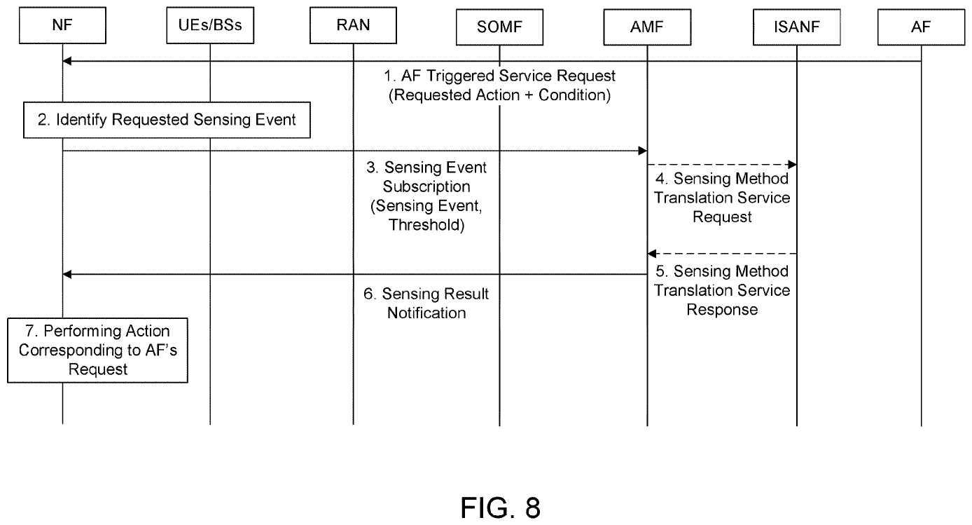

FIG. 8 shows an example of a call flow for Service Request procedure with a triggering associated with a sensing service. In this example, a Service Request message may be received from an AF, the service requested may have an associated triggering condition, and the triggering condition may be related to a sensing service.

At (1), the NF may receive a Service Request message, which may include a requested network operation and triggering condition for the network operation directly from AF, or via NEF, or PCF. Or, the NF may be configured with a policy that includes a validation condition which is relating to the sensing event.

In an example, the SMF may receive policy rules on some WTRU's session management with condition to activate the session only when intrusion detection is monitored at some service area.

In another example, the SMF may be configured to contact PCF for updating PDU session with a condition to contact PCF when a target WTRU's moving trajectory has changed.

At (2), based on the received request or configured policy, the NF may identify the requested sensing event to be monitored as condition for a network operation. For example, the NF may identify an intrusion detection service for some area with a threshold value such as it shall be reported when a number of intrusion detection exceeds the threshold value.

At (3), based on the identified sensing event, requested sensing service area and target WTRU's information, an NF may discover and select a NF (e.g., AMF) handling the sensing event and may send an Event Subscription Request message to the selected NF. The Event Subscription Request message may include the requested sensing event information, the target WTRU's information, sensing service area information, threshold value to report the sensing result. Sensing Event subscription may include the requested sensing mechanism for the sensing service.

At (4), if needed, in order to determine the sensing mechanism, the NF (e.g., AMF) may utilize the information in the Sensing Method Translation Service message. The Sensing Method Translation Service Request message may include the requested sensing service, service area information, and the target WTRU's information.

At (5), the NF (e.g., AMF) may receive the Sensing Method Translation Service Response message from the ISANF. The Sensing Method Translation Service Response message may include the sensing method executable in 5GC for the requested sensing service and list of BSs and WTRUs to perform the sensing method in the requested sensing service area or to serve sensing service based on target WTRU's location.

At (6), the NF (e.g., AMF) may initiate a sensing operation based on the information received at (3) and derive a sensing mechanism based on information from (2) and (5). The sensing operation may be similar to the sending operation described above with respect to FIG. 7, alternative D. When there is a threshold on the report of sensing event at (3), a sensing operation may be repeated until the sensing result which satisfies the threshold is acquired. When there is a sensing event of which the sensing result satisfies the threshold, the result is reported to the NF in the Sensing Result Notification message.

At (7), based on the notification result, the NF may initiate a related network operation as requested by an AF or as configured at the policy.

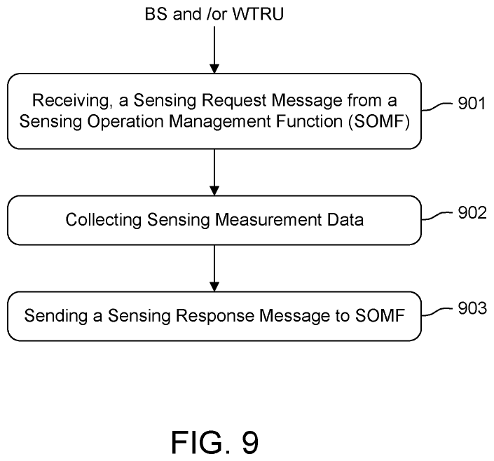

FIG. 9 shows an example flow chart of a process for performing sensing measurements by a WTRU or a BS. The process begins by receiving a Sensing Request message from a Sensing Operation Management Function (SOMF) 901. Then the process continues by collecting sensing measurement data 902. Finally, the results of the data collecting are sent in a Sensing Result message to the SOMF 903.

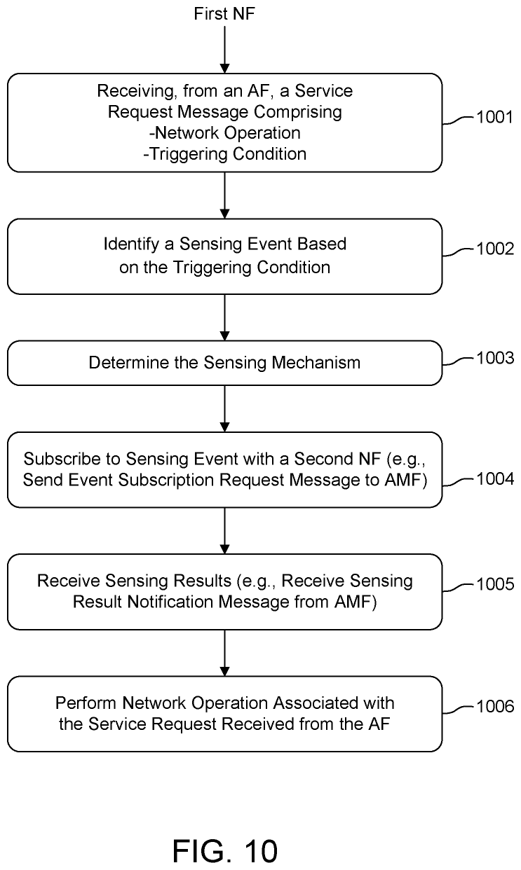

FIG. 10 shows an example flow chart of a process for exposure service of sensing events being triggered by a request for a network operation. An AF may trigger Service Request towards a first NF by sending a Service Request message to the first NF 1001. The Service Request message may be received from the AF via at least one of an Network Exposure Function (NEF) or a Policy Control Function (PCF). The Service Request message may comprise a request for a network operation and an associated triggering condition. The request may indicate that when the triggering condition is satisfied, the requested network operation is to be performed.

Based on the triggering condition, the first NF may identify the sensing event associated with the triggering condition 1002. The triggering condition may be associated with one or more sensing events. A sensing event may be characterized with one or more sensing parameters and threshold values. The sensing event may be associated with one or more WTRUs. The sensing event may be associated with the location of the one or more WTRUs. The sensing event may be associated with a specific area, which may be identified by cell identities, tracking area identities, or geofence configuration. The sensing event may be associated with a network slice at which the sensing is to be performed, which may be identified by its Single—Network Slice Selection Assistance Information (S-NSSAI). The sensing event may be associated with a configured time value, indicating the event has occurred when a certain condition is met for a time period equal to or greater than the configured time value.

The first NF may determine the sensing mechanism to be performed 1003. The sensing mechanism may be one of a network-based sensing, a WTRU-based sensing, or a collaboration-based sensing (e.g., network and WTRU collaboration).

The first NF may subscribe to the sensing event with a second NF 1004. The second NF may be an AMF; the first NF may send an Event Subscription Request message to the AMF. The subscription request may indicate an event triggered sensing service report or a periodic sensing service report, or both.

The first NF may receive sensing results from the second NF, e.g., receive a Sensing Result Notification message from the AMF 1005. Based on the received Sensing Result Notification message, the NF may initiate the related network operation as requested by the AF 1006. The results may include, for example, intrusion detection at a service area. A network operation may be, for example, a PDU session activation or a PDU session modification of the WTRUs deployed at the service area. The network operation may be associated with a configured policy.

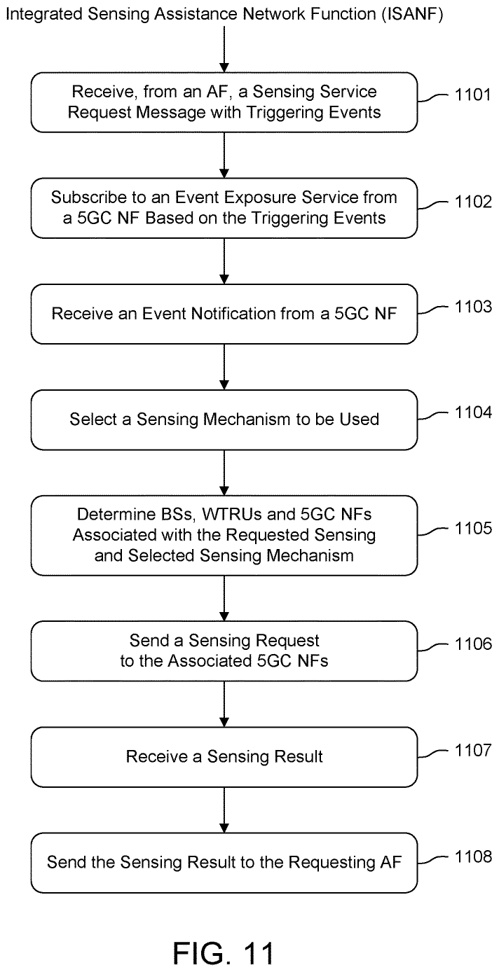

FIG. 11 shows an example flow chart of a process for exposure service of sensing events being provided to an Integrated Sensing Assistance Network Function (ISANF). The ISANF may receive, from an AF, a Sensing Service Request message 1101. The Sensing Service Request message may comprise configuration of one or more triggering events that may trigger the initiation of the requested sensing service. Based on the configured triggering events, the ISANF may subscribe to an event exposure service from NFs in the 5GC associated with the triggering events 1102. The ISANF may receive an event notification from NFs 1103. The ISANF may select a sensing mechanism to be used 1104. The sensing mechanism may be one of a network-based sensing, a WTRU-based sensing, or a collaboration-based sensing (e.g., network and WTRU collaboration). The ISANF may determine the BSs, WTRUs and 5GC NFs associated with the requested sensing and selected sensing mechanism 1105, and may send a sensing request to the determined 5GC NFs 1106. The AISNF may receive a sensing result 1107, and it may forward the result to the requesting AF 1108.

Although features and elements are described above in particular combinations, one of ordinary skill in the art will appreciate that each feature or element can be used alone or in any combination with the other features and elements. In addition, the methods described herein may be implemented in a computer program, software, or firmware incorporated in a computer-readable medium for execution by a computer or processor. Examples of computer-readable media include electronic signals (transmitted over wired or wireless connections) and computer-readable storage media. Examples of computer-readable storage media include, but are not limited to, a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs). A processor in association with software may be used to implement a radio frequency transceiver for use in a WTRU, UE, terminal, base station, RNC, or any host computer.

1. A method for integrated sensing assistance function, the method comprising:
receiving, from an application function (AF), a request for an establishment of a sensing service, the request including configuration information related to one or more triggering events that trigger an initiation of the requested sensing service;
subscribing, based on the configuration information, to an event exposure service from a first network function (NF) in a core network (CN);
receiving, from the first NF in the CN, an event notification;
determining, based on the event notification, a second NF in the CN;
selecting a sensing mechanism to be used;
sending, to a second NF in the CN, a sensing request associated with the selected sensing mechanism;
receiving, from the second NF in the CN, sensing results; and
sending, to the AF, the received sensing results.

2. The method of claim 1, wherein the received request for the establishment of a sensing service further comprises Quality of Service (QoS) requirements that include one or more of: sensing accuracy, sensing latency, sensing frequency, or sensing resolution.

3. The method of claim 1, wherein the received request for the establishment of a sensing service further comprises configuration information that identifies one or more geographical areas where the sensing is to be performed.

4. The method of claim 1, wherein the received request for the establishment of a sensing service further comprises information associated with a network slice on which the sensing is to be performed, such as a single-network slice selection assistance information (S-NSSAI).

5. The method of claim 1, wherein the one or more triggering events are associated with a Wireless Transmit-Receive Unit (WTRU) mobility event.

6. The method of claim 1, wherein the one or more triggering events are associated with a WTRU data session status.

7. The method of claim 1, wherein the event notification includes the identity of a WTRU and an access and mobility management function (AMF) serving the WTRU.

8. The method of claim 1, wherein the second NF is an AMF.

9. The method of claim 1, wherein the selected sensing mechanism to be used includes one of: a network-based sensing, a WTRU-based sensing, or a network and WTRU collaboration-based sensing.

10. The method of claim 1, wherein the sensing request sent to the second NF includes at least one of: identity of one or more base stations (e.g., eNB, gNB) for sensing operations, identity of one or more WTRUs for sensing operation, a requested sensing mechanism, sensing QoS requirements, information on a network slice at which the sensing is to be performed (e.g., S-NSSAI), or sensing area.

11. A device implementing an integrated sensing assistance function, the device comprising a processor and a communication interface, the processor and the communication interface configured to:
receive, from an application function (AF), a request for an establishment of a sensing service, the request including configuration information related to one or more triggering events that trigger an initiation of the requested sensing service;
subscribe, based on the configuration information, to an event exposure service from a first network function (NF) in a core network (CN);
receive, from the first NF in the CN, an event notification;
determine, based on the event notification, a second NF in the CN;
select a sensing mechanism to be used;
send, to a second NF in the CN, a sensing request associated with the selected sensing mechanism;
receive, from the second NF in the CN, sensing results; and
send, to the AF, the received sensing results.

12. The device of claim 11, wherein the received request for the establishment of a sensing service further comprises Quality of Service (QoS) requirements that include one or more of: sensing accuracy, sensing latency, sensing frequency, or sensing resolution.

13. The device of claim 11, wherein the received request for the establishment of a sensing service further comprises configuration information that identifies one or more geographical areas where the sensing is to be performed.

14. The device of claim 11, wherein the received request for the establishment of a sensing service further comprises information associated with a network slice on which the sensing is to be performed, such as a single-network slice selection assistance information (S-NSSAI).

15. The device of claim 11, wherein the one or more triggering events are associated with a Wireless Transmit-Receive Unit (WTRU) mobility event.

16. The device of claim 11, wherein the one or more triggering events are associated with a WTRU data session status.

17. The device of claim 11, wherein the event notification includes the identity of a WTRU and an access and mobility management function (AMF) serving the WTRU.

18. The device of claim 11, wherein the second NF is an AMF.

19. The device of claim 11, wherein the selected sensing mechanism to be used includes one of: a network-based sensing, a WTRU-based sensing, or a network and WTRU collaboration-based sensing.

20. The device of claim 11, wherein the sensing request sent to the second NF includes at least one of: identity of one or more base stations (e.g., eNB, gNB) for sensing operations, identity of one or more WTRUs for sensing operation, a requested sensing mechanism, sensing QoS requirements, information on a network slice at which the sensing is to be performed (e.g., S-NSSAI), or sensing area information.
